(19) United States
(12) Patent Application Publication
(10) Pub. No.: US 2020/0302366 A1
(43) Pub. Date: Sep. 24, 2020

(54) Decision Oriented Matrix in Conjunction with IT Infrastructure Services

(71) Applicant: International Business Machines Corporation, Armonk, NY (US)

(72) Inventors: Jitendranath Palem, Chennai (IN); Selvan Chinnakrishnan, Chennai (IN); Caryn Woodruff, Raleigh, NC (US)

(21) Appl. No.: 16/358,031

(22) Filed: Mar. 19, 2019

(51) Int. Cl. G06Q 10/06; G06N 7/00

(52) U.S. Cl. CPC G06Q 10/06393; G06N 7/005

(57) ABSTRACT

Integrating service performance data is provided. Client satisfaction data for a service provider is collected from a number of data sources. Operational data for the service provider is also collected from a number of data sources. The client satisfaction data is correlated with the operational data according Bayesian probability distributions. The correlated data is categorized into different performance zones according to a number of business rules. The client satisfaction data and operational data are then displayed in a matrix graphical user interface comprising a number of matrix cells, wherein each matrix cell represents a performance zone to denote a status of a service project. Clients are then assigned to each zone according to a Bayesian probability.

### BACKGROUND

The disclosure relates generally to data processing, and more specifically to specialized graphical interface for integrating different data sources.

Businesses seek to create positive, enthusiastic clients who will become repeat buyers as well as spread the word about a business's products and service. This is typically known as client satisfaction, client loyalty or the best client experience. For service-oriented organizations, it is particularly important to keep these goals in mind.

Beyond the priority of retaining good clients, businesses want to increase the purchase value of current clients and get them to become advocates in the marketplace. Client relationship survey scores are critical to organizations in understanding how their services are perceived by their clients and is a strong indication of repeat business. It is an annual client satisfaction survey that provides the organization with feedback from clients. It is an important means of understanding clients' expectations in selecting an organization as a partner and gathering feedback on key strengths and areas for improvement.

The Net Promoter Score (NPS) is usually used for the measurement of Client satisfaction. NPS is collected using an 11 point scale (0 to 10) to answer the simple question, “How likely are you to recommend The Company?” Clients who respond 0 to 6 are Detractors. Clients who respond with 7 or 8 are Passive, and people who respond with 9 or 10 are Promoters. Net Promoter Score is simply calculated as: % of Promoters−% of Detractors. An NPS score greater than 0 is considered to be positive. An NPS higher than 50% is excellent.

A service provider's internal dashboard to track project health is a proactive service management tool that provides service management professionals with a real-time dashboard to view the key metrics that are critical to achieving service delivery excellence. Usually, a client is defined as a collection of contracts under the same account management team, and for many clients this can include contracts in multiple countries. The project health dashboard is used to track and report on the client health of accounts supported by IT services. Account health related information is typically updated monthly, and an overall health score is calculated automatically by the tool based on agreed criteria such as in a service level agreement.

However, it is easy to fall into the trap of focusing more on satisfaction survey results and the percentages of clients who fall into the top or bottom on the surveys, than on the underlying human behaviors that drive the ranking. It is at the behavioral level where businesses can make human connections that result in client satisfaction and loyalty.

Similarly, possessing metrics regarding operational performance does not directly translate into insight regarding client decisions to retain service or promote the service to others. Simply having a collection of data from client feedback and service operations does not facilitate holistic decision making at the strategic level.

### SUMMARY

An illustrative embodiment provides a method of integrating service performance data, comprising collecting, by a number of processors, client satisfaction data for a service provider from a number of data sources; collecting, by a number of processors, operational data for the service provider from a number of data sources; correlating, by a number of processors, the client satisfaction data with the operational data according Bayesian probability distributions; categorizing, by a number of processors, the correlated client satisfaction data and operational data into number of performance zones according to a number of business rules; displaying, by a number of processors, the client satisfaction data and operational data in a matrix graphical user interface comprising a number of matrix cells, wherein each matrix cell represents a different performance zone to denote a status of a service project; and assigning, by a number of processors, a number of clients to respective performance zones in the matrix according to a Bayesian probability.

Another illustrative embodiment provides a system for integrating service performance data, comprising: a bus system; a storage device connected to the bus system, wherein the storage device stores program instructions; and a processor connected to the bus system, wherein the processor executes the program instructions to: collect client satisfaction data for a service provider from a number of data sources; collect operational data for the service provider from a number of data sources; correlate the client satisfaction data with the operational data according Bayesian probability distributions; categorize the correlated client satisfaction data and operational data into number of performance zones according to a number of business rules; display the client satisfaction data and operational data in a matrix graphical user interface comprising a number of matrix cells, wherein each matrix cell represents a different performance zone to denote a status of a service project; and assign a number of clients to respective performance zones in the matrix according to a Bayesian probability.

Another illustrative embodiment provides a computer program product for integrating service performance data, comprising, the computer program product comprising a non-volatile computer readable storage medium having program instructions embodied therewith, the program instructions executable by a computer to cause the computer to perform the steps of: collecting client satisfaction data for a service provider from a number of data sources; collecting operational data for the service provider from a number of data sources; correlating the client satisfaction data with the operational data according Bayesian probability distributions; categorizing the correlated client satisfaction data and operational data into number of performance zones according to a number of business rules; displaying the client satisfaction data and operational data in a matrix graphical user interface comprising a number of matrix cells, wherein each matrix cell represents a different performance zone to denote a status of a service project; and assigning a number of clients to respective performance zones in the matrix according to a Bayesian probability.

### BRIEF DESCRIPTION OF THE DRAWINGS

FIG. 1 depicts a pictorial representation of a network of data processing systems in which illustrative embodiments can be implemented;

FIG. 2 depicts a system architecture for integrating and presenting multiple data sources related to client services in a user interface;

FIG. 3 depicts a Bayesian belief network in accordance with illustrative embodiments;

FIG. 4 is a diagram depicting a graphical user interface displaying a decision-oriented matrix in which illustrative embodiments can be implemented;

FIG. 5 is a flowchart depicting the process of creating and automatically updating a decision matrix in accordance with illustrative embodiments; and

FIG. 6 is a diagram of a data processing system is depicted in accordance with an illustrative embodiment.

### DETAILED DESCRIPTION

Aspects of the present disclosure are described herein with reference to diagrams of methods and apparatuses according to embodiments of the disclosure. The diagrams in the Figures illustrate the architecture and operation of possible implementation methods according to various embodiments of the present disclosure.

Embodiments recognize and take into account that client satisfaction is a deceptively complex concept, and when it comes to techniques for measuring it, one size does not fit all. The survey-driven Client Satisfaction Score (CSAT), Net Promoter Score (NPS), or client relationship survey score each present a different piece of the puzzle but all of them oversimplify. Product and service improvements depend upon consumer feedback, but as the number of surveys and scoring options increase, decisions makers are presented with a growing collection numbers that are incoherent without providing insight into the underlying factors that generate the numbers in the first place.

Embodiments also recognize and take into account that the NPS concept itself can be deceptively simple and potentially very impactful if used properly, but it does not paint the entire picture. The NPS and a true overall client satisfaction are completely different. The NPS asks client about their likeliness to recommend a service based on the relationship they have with the provider, whereas client relationship survey asks them about their overall satisfaction with the performance of the service provider over the past year. Therefore, while a client might give an overall satisfaction rating of a ‘2’ or ‘3’ (based on a 5-point scale) because they are unhappy with a particular issue/problem they are currently experiencing at the moment the client relationship survey is taken, they might still provide a very high rating for the NPS because they are pleased with the overall relationship. As such a simple metric does not provide an accurate, three-dimensional picture as to what is really happening within an organization.

Embodiments recognize and take into account that whichever scoring system is used, the score itself does not provide information regarding the underlying reasons why clients score service providers the way they do.

The illustrative embodiments provide a decision-oriented matrix correlating the relationship between client satisfaction data with operational data. Assigning names or labels for each cell in the matrix helps project managers and business owners to identify status of the project in terms of understanding key drivers behind client satisfaction. By employing Bayesian probability distributions, the illustrative embodiments provide the technical improvement of more accurately classifying and visualizing client status in relation to operational data using less computing time and improving decisions making speed.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

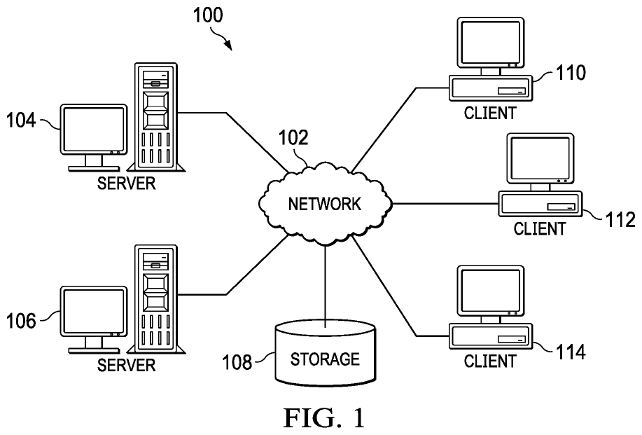

FIG. 1 depicts a pictorial representation of a network of data processing systems in which illustrative embodiments can be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide a set of one or more connector services for managing idempotent operations on a system of record, such as storage 108. An idempotent operation is an identical operation, which was previously performed or executed, that has the same effect as performing a single operation. Also, it should be noted that server 104 and server 106 may each represent a plurality of servers providing management of idempotent operations for a plurality of system of records.

Client 110, client 112, and client 114 also connect to network 102. Clients 110, 112, and 114 are clients of server 104 and server 106. Server 104 and server 106 may provide information, such as boot files, operating system images, and software applications to clients 110, 112, and 114.

In this example, clients 110, 112, and 114 are shown as desktop or personal computers. However, it should be noted that clients 110, 112, and 114 are intended as examples only. In other words, clients 110, 112, and 114 may include other types of data processing systems, such as, for example, network computers, laptop computers, tablet computers, handheld computers, smart phones, smart watches, personal digital assistants, gaming devices, set-top boxes, kiosks, and the like. Users of clients 110, 112, and 114 may utilize clients 110, 112, and 114 to access system of records corresponding to one or more enterprises, via the connector services provided by server 104 and server 106, to perform different data operations. The operations may be, for example, retrieve data, update data, delete data, store data, and the like, on the system of records.

Storage 108 is a network storage device capable of storing any type of data in a structured format or an unstructured format. In addition, storage 108 may represent a plurality of network storage devices. Further, storage 108 may represent a system of record, which is an authoritative data source, corresponding to an enterprise, organization, institution, agency, or similar entity. Furthermore, storage unit 108 may store other types of data, such as authentication or credential data that may include user names, passwords, and biometric data associated with client users and system administrators, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), and a wide area network (WAN). FIG. 1 is intended as an example only, and not as an architectural limitation for the different illustrative embodiments.

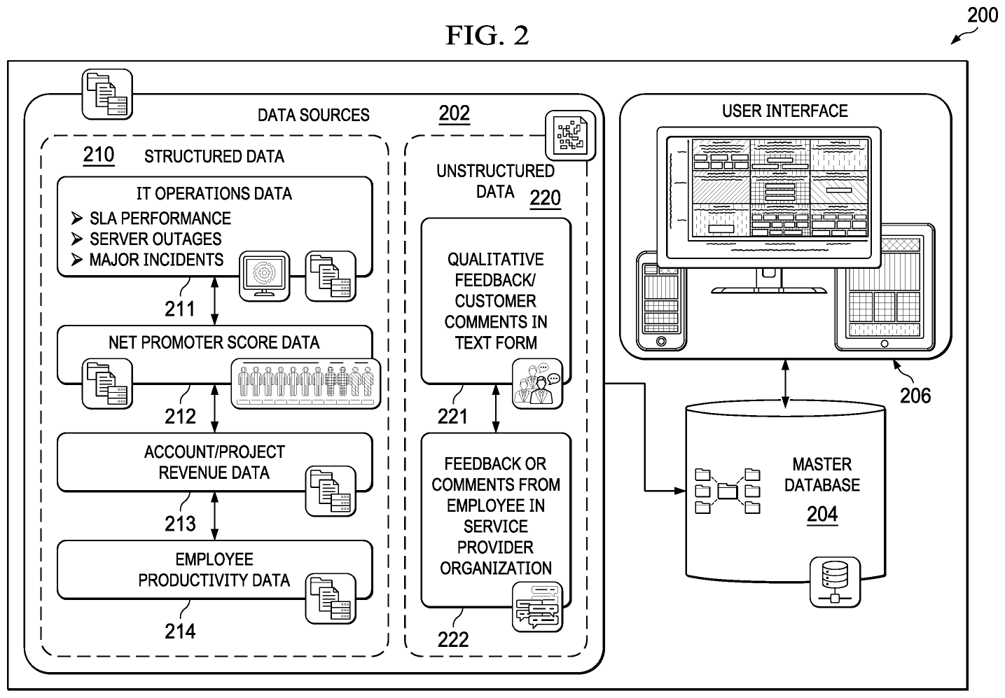

FIG. 2 depicts a system architecture for integrating and presenting multiple data sources related to client services in a user interface. The data integration system 200 comprises a number of data sources 202. Generally speaking, the data sources 202 can be divided into structured data 210 and unstructured data 220.

Structured data 210 comprises data gathered through formal channels and procedures, including both client satisfaction data and operational data. It generally comprises categories that are quantitative in nature. In the present example, structured data 210 includes IT operations data 211 such as service level agreement (SLA) performance, server outages, and predefined major incidents (e.g., network disruptions, civil unrest, etc.). The specific type of data does not have to be for IT and can differ depending on the specific type of service, but in general these data represent hard metrics concerning the technical aspects of service delivery. Similar types of operational data include account/service revenue data 213 and employee productivity data 214.

A project health dashboard is used by service management (SM) to track and report on the client health of the accounts supported by IT delivery. Account health related information is typically updated by the project executives monthly. For example, the overall health in terms of a Green/Amber/Red score is calculated automatically by the tool based on the global SM agreed-to criteria.

Also included in the structured data 210 are quantifications related to client satisfaction. In the present example, NPS data 212 forms part of the structured data 210. Other client satisfaction indicators such as client relationship survey and CSAT can also be included in the structured data 210 but are excluded from the present example merely for purposes of ease of illustration. But a key element in all aspects of structured data 210 is the deliberate and systematic collection of the data according to defined categories.

Unstructured data 220 comprises qualitative feedback from more informal data sources such as client comments in text form 221 as for example on social media and review websites that are not organized by the service provider or industry. Such sources of client feedback are incredibly diverse and continually growing. They also tend to provide insight regarding the rationale underlying client/client satisfaction that are difficult to capture in more formally structured surveys.

In addition to client feedback 221 emanating from outside the service provider, unstructured data 220 also includes employee feedback and comments 222 from employees working in the service provider organization. This type of “boots on the ground” feedback can provide insight regarding the cause and effect relationships between how the service provider operates and the effects on client/client satisfaction, in contrast to operational statistics that merely capture results rather than an understanding how or why those results were generated.

Both the structured 210 and unstructured 220 data from the diverse data sources 202 are integrated and correlated in a master database 204. The correlations between client satisfaction data and operational data are displayed on a graphical user interface 206 that be displayed on a variety of display devices.

During data collection, parameters from structured data sources such as client relationship surveys, operations data, and financial parameters are treated as independent variables that are merged into a single datasheet using a unique account identifier (ID). Using the independent variables, illustrative embodiments build a probabilistic model of dependent variables to predict a likelihood of overall responsiveness (i.e., 0—Responsive, 1—Default).

The independent variables comprise discrete variable and ordinal data types that can be represented on a scale (i.e. 1-10) or as binary values (i.e. yes/no). The specific independent variables used can be customized for different service providers according to their respective business parameters and objectives. Examples of possible independent variables include likelihood of purchasing from the service provider again, likelihood of recommending the service provider, support, meeting commitments, value, innovation, contract issues, cost/price, resource availability, transition and transformation, application maintenance services, delivery, request for service (RFS) solution, and RFS implantation.

To clean the dataset, missing values can be imputed with mode since all of the discrete variables are discrete. Important variables are identified since not all of the independent variables contribute significantly to the dependent variable (i.e. overall responsiveness). The data is well balanced with a 49:51 ratio of class label. Validation of dependency can be performed using the correlation and chi squared test to determine the significance of the independent variables with overall responsiveness.

Cross validation (e.g., K-fold) can be used to split the data into a training set and a test set. Training of the model can be performed by splitting the dataset into k consecutive folds, wherein each fold is used once as a validation while the k−1 remaining folds form the training set.

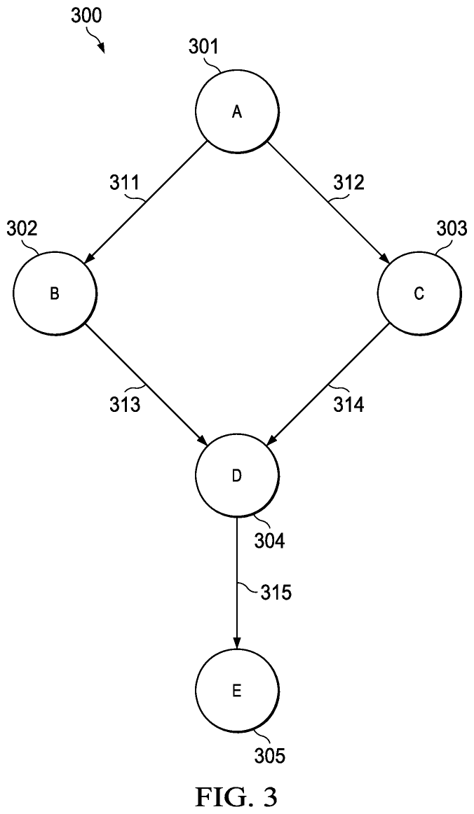

Turning now to FIG. 3, a Bayesian belief network is depicted in accordance with illustrative embodiments. A Bayesian belief network is a probabilistic model that represents a set of random variables and their conditional dependencies via a directed acyclic graph. For a given event, Bayesian networks can predict the likelihood that any one of several known possible causes is a contributing factor and provide a graphical model of causal relationship on which learning can be performed.

Bayesian networks specify joint conditional probability distributions and allow class conditional independencies to be defines between subsets if variables. Illustrative embodiments use a trained Bayesian network 300 for classification.

There are two components that define a Bayesian belief network 1) a directed acyclic graph, and 2) a set of conditional probability tables. The directed acyclic graph comprises nodes 301-305 representing random variables A, B, C, D, and E, respectively, and edges 311-315 indicating conditional dependence relations.

At a qualitative level, the structure of a Bayesian network describes the relationships between multiple interacting entities in the form of conditional independence relations. At a quantitative level, local relationships between the interacting entities are described by conditional probability distributions. Formally, a Bayesian network is defined by a graphical structure, M, a family of conditional probability distributions, F, and their parameters, q, which together specify a joint distribution over a set of random variables of interest.

For example, letting X₁,X₂, . . . ,Xₙ be a set of random variables represented by nodes i∈{1, . . . ,n}, pa[i] is defined to be the parents of node i, and X_{pa[i]} represents the set of random variables associated with pa[i]. The probability distributions are represented:

P(X₁,X₂, . . . ,Xₙ)=Πᵢ₌₁ⁿP(Xᵢ|X_{pa[i]})

An equivalent way of expressing these independence relations is based on the concept of the Markov blanket, which is the set of children, parents, and coparents (that is, other parents of the children) of a given node. This set shields the selected node from the remaining nodes in the graph. So, if MB[i] is the Markov blanket of node i, and X_{MB[i}] is the set of random variables associated with MB[i], then

P(Xₖ|₁,Xₖ₋₁,ₖ₊₁, . . . ,Xₙ)=P(Xₖ|X_{MB[i]})

Applying this relationship to the variable nodes in FIG. 3 produces:

$$\begin{matrix}P ( C \vert A , B , D , E ) = \frac{P ( A , B , C , D , E )}{P ( A , B , D , E )} \\ = \frac{P ( A ) P ( B \vert A ) P ( C \vert A ) P ( D \vert B , C ) P ( E \vert D )}{{\sum }_{C} P ( A ) P ( B \vert A ) P ( C \vert A ) P ( D \vert B , C ) P ( E \vert D )} \\ = \frac{P ( A ) P ( E \vert D ) P ( B \vert A ) P ( C \vert A ) P ( D \vert B , C )}{P ( A ) P ( E \vert D ) P ( B \vert A ) {\sum }_{C} P ( C \vert A ) P ( D \vert B , C )} \\ = \frac{P ( C \vert A ) P ( D \vert B , C )}{{\sum }_{C} P ( C \vert A ) P ( D \vert B , C )}\end{matrix}$$

Expanding the joint probability

P(A,B,C)=P(A|C)P(B|C)P(C)

for the conditional probability P(A,B|C) thus obtains:

$$P ( A , B \vert C ) = \frac{P ( A , B , C )}{P ( C )} = P ( A \vert C ) P ( B \vert C )$$

Hence, A and B are conditionally independent given C. It should be noted, however, that this independence does not carry over to the marginal probabilities, and that in general

P(A,B)≠P(A)P(B)

For the conditional probability we thus obtain:

$$P ( A , B \vert C ) = \frac{P ( A , B , C )}{P ( C )} = P ( B \vert C ) \frac{P ( C \vert A ) P ( A )}{P ( C )} = P ( B \vert C ) P ( A \vert C )$$

Marginalizing over C produces

P(A,B)=Σ_{C}P(A,B,C)=P(A)P(B)

wherein a probability function is normalized

Σ_{C}P(C)A,B)=1

A and B are marginally independent. However, it cannot be shown, in general, that the same holds for the conditional probabilities.

Given the data, first the posterior distribution of network structures M is found, and from this distribution the structure M* that is most supported by the data is found, where

M*=

[symbol]

Given the best structure M* and the data, the posterior distribution of the parameters, q, and the best parameters are found:

where q*=argmax_{q}^{{P(q|} [symbol] ^{*,} [symbol] ^{)}}

Applying Bayes' rule: P(M|D)∝P(D|M)P(M)

where the marginal likelihood P(D|M) implies an integration over the whole parameter space:

P( [symbol] | [symbol] )=∫P( [symbol] |q, [symbol] )P(q| [symbol] )d

Assuming that the posterior probability P(q|D,M) is unimodal and peaked around its mode, q\hat{ }, with width [symbol] qₚₒₛₜ, and assuming that the prior can be approximated by a distribution that is uniform over some large interval [symbol] qₚᵣᵢₒᵣ yields

P( [symbol] | [symbol] )=P( [symbol] |\hat{q}, [symbol] )

[symbol]

The first term on the right-hand side, P(D|q\hat{ },M) is the likelihood, evaluated at the maximum likelihood parameters (note that for a uniform prior P(q|M), the maximum a posterior probability (MAP) estimate q\hat{ } is equal to the maximum likelihood estimate). Obviously, the likelihood is maximized for a complex structure with many edges, which is bound to over-fit to the observed data, D. The second term on the righthand side, [symbol] qₚₒₛₜ/ [symbol] qₚᵣᵢₒᵣ, referred to as the Occam factor, measures the ratio of the posterior and prior accessible volumes in parameter space. For an over-complex model, this ratio will be small.

Once the model learns from the training dataset, it is tested with the test dataset to check it performance. A confusion matrix can be used to evaluate the error rate to check how the model is able to learn from data to predict the probability of “overall responsiveness” is “NO”. A confusion matrix allows visualization of performance of an algorithm. Instances in a predicted class are compared against instances in an actual class to see if the algorithm is confusing two classes. Receiver operating characteristic area under curve (ROC-AUC) can be used to check overall performance of the model. The greater the AUC, the better the model is able to learn from the dataset.

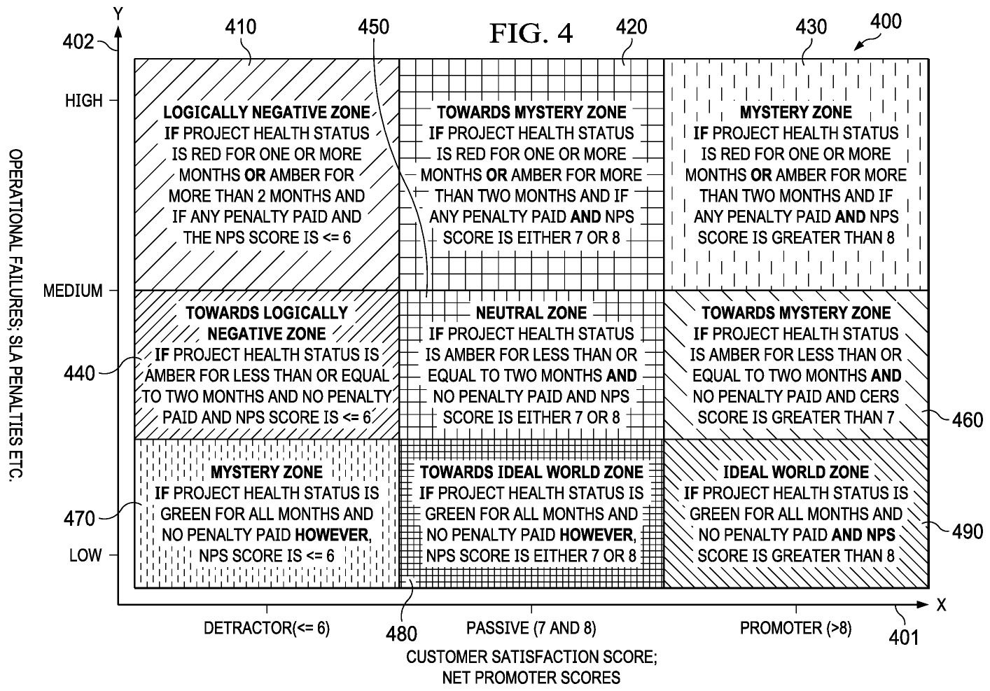

FIG. 4 is a diagram depicting a graphical user interface displaying a decision-oriented matrix in which illustrative embodiments can be implemented. In this example, the graphical user interface matrix 400 comprises nine cells 410-490. It should be emphasized that more or fewer cells can be used depending the needs and preferences of the user.

In the present example, client satisfaction data are represented along the X axis 301, and operational data are represented along the Y axis 402. The matrix 400 facilitates correlation of client satisfaction data with operational data by applying different business rules to the data. Statistical analysis of the relationship between the X and Y axis categories is performed depending on the data type, e.g., Chi-square, etc. Each cell 410-490 in the matrix 400 represents a different business rule.

In the example shown in FIG. 4, the matrix 400 depicts the correlation of client relationship survey/NPS scores and project health dashboard scores. It should be understood that other categories of scores (e.g., CSAT, etc.) or can be represented along each axis. The label applied to each cell reflects not only combined operational and client satisfaction metric but also the degree of congruity (or lack thereof) between calculated client satisfaction and operational performance over the specified time periods.

The diagonal cells 410, 450, and 490 represent a direct correlation and congruity between operational statistics and client satisfaction scores, which is the type of correlation that is expected and often implicitly assumed by decision makers. For example, referring to the “Logically Negative Zone” in cell 410, the project health dashboard status is red for one or more months or is Amber for more than 2 months and penalty paid, and the client relationship survey score is less than 6. These scores reflect a high degree of operational failures represented by, e.g., SLA penalties, and a concomitant low client satisfaction that indicates the client is a detractor of the service provider. In contrast, the “Ideal World Zone” depicted in cell 490 reflects a project health dashboard status that is green for all months and no SLA penalties paid and a client relationship survey score greater than 7. These zones appear to exhibit the “Pay for Performance” scenario, where the project health dashboard status directly results in predictable client relationship survey scores.

In the case of the Ideal World Zone cell 490, it is important to understand if this is a temporary spike which resulted from the most recent best performance of the team or whether the team performed so consistently for at least six months. Decisions makers need to understand the contributors to this success. Is the success by design or is it by chance? A good understanding of the contributors enables the organization to benchmark its client relationship management. This case results in happy clients which means repeat business and lower client retention costs. In contrast, the Logically Negative Zone cell 410 can be likened to a death knell for those clients and calls for immediate measures and actions to improve the client satisfaction.

The “Mystery Zones” cells 430 and 470 represent contrasting situations in which the operational scores and client/client satisfaction scores are completely incongruent with each other. The specific visualization provided by the graphical user interface matrix 400 alerts decision makers to such incongruities that might otherwise escape the notice of decision makers who are evaluating the data independently of each other.

Referring to Mystery Zone cell 470, the project health dashboard status is green for all months and no penalties have been paid, but the client relationship survey score is under 6, indicating a potential detractor. This situation could indicate that though the financials look good, there is a huge gap between what the client needs or expects the organization to deliver and what the organization is actually delivering. The requirements might not be understood correctly, or the client might be looking for the organization to deliver over and above their contractual obligations to meet their other impending commitments like improving their bottom line. Detailed discussions with clients might help bridge the gaps in understanding and meeting the client's expectations.

Mystery Zone cell 430, represents the inverse situation from that represented by cell 470. In this case the project health dashboard status is red for one or more months or is Amber for more than 2 months, but the client relationship survey score is greater than 7, indicating a situation marked by a high rate of operational failures in meeting contractual service requirements but also high client satisfaction nonetheless. Such as situation calls for very close introspection. Is it a result of excellent client relationship management? Was there a change in the client facing personnel who maintained a good rapport with the client? Is there a change in the client leadership or management team who are very much in favor of the service providing organization because of past performance? Immediate action needs to be taken in converting the organization's performance to tangible deliverables resulting in a better project health dashboard status. However, before such questions can be addressed, decision makers have to be aware of the situation in the first place. The visualization provided by the decision matrix 400 facilitates identifying these critical and somewhat counterintuitive scenarios.

Using the Bayesian belief network 300, the objective is to minimize the probability of responsiveness being “No” to improve the overall client relationship survey scores. Data 1 (D1) comprises the horizontal axis in FIG. 4 representing client satisfaction/net promotor score. Data 2 (D2) comprises the vertical axis representing operational performance.

There are seven parameters in decision matrix 400 to signify each client zone. These parameters are: logically negative zone (A), towards logically negative zone (B), mystery zone (C), towards mystery zone (D), neutral zone (E), towards ideal world zone (F), and ideal world zone (G). Each client is defined by Ci, wherein C1, C2, C2, . . . Ci are clients. D1 comprises the random variable NPS, which has three levels: low (L1)=detractor scores, neutral (N1)=passive scores, and high (H1)=promoter scores. D2 comprises the random variable Operational Measures Status, which also has three levels: low (L2), medium (M2), and high (H2).

The Bayesian approach is used to compute the conditional independence probabilities of each parameter in the matrix. The objective is to build a conditionality model based on the D1 and D2 columns defined above and classify clients who would fall into each zone respectively.

Using the example of event L1 from D1 and L2 from D2 for client C1, the following conditional independence rules can be applied:

IF ΣP(A/L1&L2) over Ci>0.5 THEN “Mystery Zone”

wherein the threshold of 0.5 is used to classify each respective zone for each client.

ρP(A/L1&L2)=ΣP(L1&L2/A)*P(A)/P(L1&L2)

L1&L2 are independent and constant so the normalized equation would be

ρP(A/L1&L2)∞ΣP(L1&L2/A)*P(A)

if probability is >0.5 then the client is classifies in “Mystery Zone.”

The probabilities of all clients are computed respectively, and the clients are classified in the decision matrix 400 according to the algorithm where:

D=D1+D2## merging two data

For Ci in 1:nrow(D): ## each row represents a client

The Bayesian probability is computed:

IF (ΣP(A/L1&L2)=P(L1&L2/A)*P(A)/P(L1&L2))>0.5# it will compute the prob and check the prob value with threshold value.

THEN classify the ci in Zone Z1.### It will classify the client in Zone.

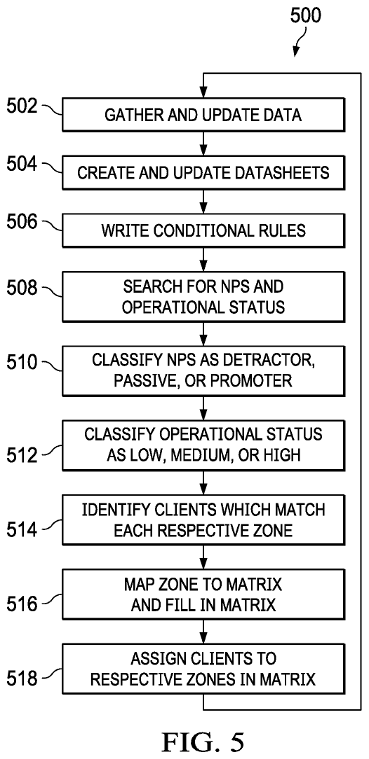

FIG. 5 is a flowchart depicting the process of creating and automatically updating a decision matrix in accordance with illustrative embodiments. Process 500 begins by gathering and updating operational data and client feedback data (step 502). Process 500 uses this gathered data to create and populate two datasheets (step 504). The first datasheet comprises five columns: 1) NPS, 2) operational measures status, 3) probability results, 4) clients, and 5) zones. Each row represents a client. The second datasheet comprises the 3×3 decision matrix. Next conditional business rules are written for automatically picking zones according to probability distributions (step 506).

The algorithm searches the first datasheet for the columns for NPS and operational measures status (step 508). For each row, i, in the first datasheet the algorithm determines if the NPS score indicates detractor, passive, or promotor (step 510) and if the operational measures status is equal to low, medium, or high (step 512). If should be noted that steps 510 and 512 can occur in reverse order. The order shown in FIG. 5 is merely chosen for illustrative convenience.

Based on the values for the NPS and operational measures status for each row, i, the algorithm identifies the clients from the client column in the first datasheet which match the respective zone (step 514). Once the algorithm identifies all the clients based on all possible conditional rules for the 3×3 matrix it updates the decision matrix in the second datasheet by mapping the zones to the matrix and filling each section of the matrix with the respective zone (step 516).

The algorithm then assigns the clients identified in step 514 to the respective zone in each matrix section and populates the matrix (step 518). As new operational data and client feedback is received, the data is gathered and updated again in step 502, and the process repeats.

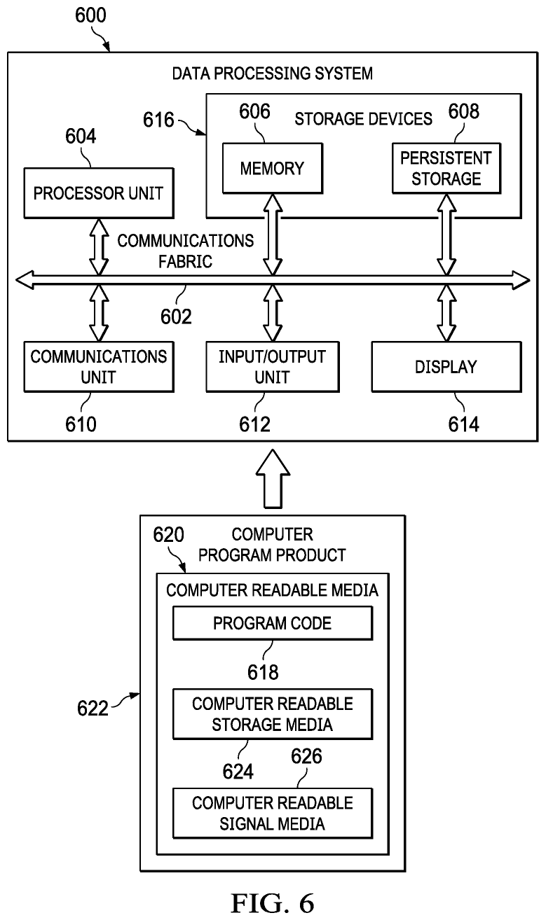

Turning to FIG. 6, a diagram of a data processing system is depicted in accordance with an illustrative embodiment. Data processing system 600 is an example of a system in which computer-readable program code or program instructions implementing processes of illustrative embodiments may be run. Data processing system 600 may be an example of one system in which root cause analysis system 116 in FIG. 1 may be implemented. In this illustrative example, data processing system 600 includes communications fabric 602, which provides communications between processor unit 604, memory 606, persistent storage 608, communications unit 610, input/output unit 612, and display 614.

Processor unit 604 serves to execute instructions for software applications and programs that may be loaded into memory 606. Processor unit 604 may be a set of one or more hardware processor devices or may be a multi-processor core, depending on the particular implementation. Further, processor unit 604 may be implemented using one or more heterogeneous processor systems, in which a main processor is present with secondary processors on a single chip. As another illustrative example, processor unit 604 may be a symmetric multi-processor system containing multiple processors of the same type.

A computer-readable storage device is any piece of hardware that is capable of storing information, such as, for example, without limitation, data, computer-readable program code in functional form, and/or other suitable information either on a transient basis and/or a persistent basis. Further, a computer-readable storage device excludes a propagation medium. Memory 606, in these examples, may be, for example, a random access memory, or any other suitable volatile or non-volatile storage device. Persistent storage 608 may take various forms, depending on the particular implementation. For example, persistent storage 608 may contain one or more devices. For example, persistent storage 608 may be a hard drive, a flash memory, a rewritable optical disk, a rewritable magnetic tape, or some combination of the above. The media used by persistent storage 608 may be removable. For example, a removable hard drive may be used for persistent storage 608.

Communications unit 610, in this example, provides for communication with other computers, data processing systems, and devices via network communications unit 610 may provide communications using both physical and wireless communications links. The physical communications link may utilize, for example, a wire, cable, universal serial bus, or any other physical technology to establish a physical communications link for data processing system 600. The wireless communications link may utilize, for example, shortwave, high frequency, ultra-high frequency, microwave, wireless fidelity (WiFi), Bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 600.

Input/output unit 612 allows for the input and output of data with other devices that may be connected to data processing system 600. For example, input/output unit 612 may provide a connection for user input through a keypad, keyboard, and/or some other suitable input device. Display 614 provides a mechanism to display information to a user and may include touch screen capabilities to allow the user to make on-screen selections through user interfaces or input data, for example.

Instructions for the operating system, applications, and/or programs may be located in storage devices 616, which are in communication with processor unit 604 through communications fabric 602. In this illustrative example, the instructions are in a functional form on persistent storage 608. These instructions may be loaded into memory 606 for running by processor unit 604. The processes of the different embodiments may be performed by processor unit 604 using computer-implemented program instructions, which may be located in a memory, such as memory 606. These program instructions are referred to as program code, computer-usable program code, or computer-readable program code that may be read and run by a processor in processor unit 604. The program code, in the different embodiments, may be embodied on different physical computer-readable storage devices, such as memory 606 or persistent storage 608.

Program code 618 is located in a functional form on computer-readable media 620 that is selectively removable and may be loaded onto or transferred to data processing system 600 for running by processor unit 604. Program code 618 and computer-readable media 620 form computer program product 622. In one example, computer-readable media 620 may be computer-readable storage media 624 or computer-readable signal media 626. Computer-readable storage media 624 may include, for example, an optical or magnetic disc that is inserted or placed into a drive or other device that is part of persistent storage 608 for transfer onto a storage device, such as a hard drive, that is part of persistent storage 608. Computer-readable storage media 624 also may take the form of a persistent storage, such as a hard drive, a thumb drive, or a flash memory that is connected to data processing system 600. In some instances, computer-readable storage media 624 may not be removable from data processing system 600.

Alternatively, program code 618 may be transferred to data processing system 600 using computer-readable signal media 626. Computer-readable signal media 626 may be, for example, a propagated data signal containing program code 618. For example, computer-readable signal media 626 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer-readable media also may take the form of non-tangible media, such as communication links or wireless transmissions containing the program code.

In some illustrative embodiments, program code 618 may be downloaded over a network to persistent storage 608 from another device or data processing system through computer-readable signal media 626 for use within data processing system 600. For instance, program code stored in a computer-readable storage media in a data processing system may be downloaded over a network from the data processing system to data processing system 600. The data processing system providing program code 618 may be a server computer, a client computer, or some other device capable of storing and transmitting program code 618.

The different components illustrated for data processing system 600 are not meant to provide architectural limitations to the manner in which different embodiments may be implemented. The different illustrative embodiments may be implemented in a data processing system including components in addition to, or in place of, those illustrated for data processing system 600. Other components shown in FIG. 6 can be varied from the illustrative examples shown. The different embodiments may be implemented using any hardware device or system capable of executing program code. As one example, data processing system 600 may include organic components integrated with inorganic components and/or may be comprised entirely of organic components excluding a human being. For example, a storage device may be comprised of an organic semiconductor.

As another example, a computer-readable storage device in data processing system 600 is any hardware apparatus that may store data. Memory 606, persistent storage 608, and computer-readable storage media 624 are examples of physical storage devices in a tangible form.

In another example, a bus system may be used to implement communications fabric 602 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 606 or a cache such as found in an interface and memory controller hub that may be present in communications fabric 602.

The present invention may be a system, a method, and/or a computer program product. The computer program product may include a computer-readable storage medium or media having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer readable program instructions to personalize the electronic circuitry, in order to perform aspects of the present invention.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, it should be understood that embodiments discussed herein are not limited to the particular features and processing steps shown. The flowchart and diagrams in the figures illustrate the method and resulting architecture according to embodiments of the present disclosure. In this regard, each block in the flowchart or structural diagrams may represent a step or partial step, which comprise one or more procedures for implementing the illustrative embodiments. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of integrating service performance data, comprising:
collecting, by a number of processors, client satisfaction data for a service provider from a number of data sources;
collecting, by a number of processors, operational data for the service provider from a number of data sources;
correlating, by a number of processors, the client satisfaction data with the operational data according Bayesian probability distributions;
categorizing, by a number of processors, the correlated client satisfaction data and operational data into number of performance zones according to a number of business rules;
displaying, by a number of processors, the client satisfaction data and operational data in a matrix graphical user interface comprising a number of matrix cells, wherein each matrix cell represents a different performance zone to denote a status of a service project; and
assigning, by a number of processors, a number of clients to respective performance zones in the matrix according to a Bayesian probability.

2. The method of claim 1, wherein the client satisfaction data comprises at least one of:
client relationship survey scores;
Net Promoter Score (NPS);
client satisfaction (CSAT) scores;
client comments in text form.

3. The method of claim 1, wherein operational data comprises at least one of:
project health dashboard status;
service level agreement (SLA) penalties;
key performance indicator (KPI) data;
service outages;
project revenue data;
employee productivity data;
predefined major incidents;
comments from service provider employees.

4. The method of claim 1, wherein the data sources comprise structured data.

5. The method of claim 1, wherein the data sources comprise unstructured data.

6. The method of claim 1, wherein the matrix cells are organized along a first axis representing client satisfaction and a second axis representing operational performance, and wherein each matrix cell is labelled according to a combined range of calculated client satisfaction and operational performance over specified time periods.

7. The method of claim 6, wherein each matrix cell is further labelled according to a degree of congruity between calculated client satisfaction and operational performance over the specified time periods.

8. A system for integrating service performance data, comprising:
a bus system;
a storage device connected to the bus system, wherein the storage device stores program instructions; and
a processor connected to the bus system, wherein the processor executes the program instructions to:
collect client satisfaction data for a service provider from a number of data sources;
collect operational data for the service provider from a number of data sources;
correlate the client satisfaction data with the operational data according Bayesian probability distributions;
categorize the correlated client satisfaction data and operational data into number of performance zones according to a number of business rules;
display the client satisfaction data and operational data in a matrix graphical user interface comprising a number of matrix cells, wherein each matrix cell represents a different performance zone to denote a status of a service project; and
assign a number of clients to respective performance zones in the matrix according to a Bayesian probability.

9. The system of claim 8, wherein the client satisfaction data comprises at least one of:
client relationship survey scores;
Net Promoter Score (NPS);
client satisfaction (CSAT) scores;
client comments in text form;
comments from service provider employees.

10. The system of claim 8, wherein operational data comprises at least one of:
project health dashboard status;
service level agreement (SLA) penalties;
key performance indicator (KPI) data;
service outages;
project revenue data;
employee productivity data;
predefined major incidents.

11. The system of claim 8, wherein the data sources comprise structured data.

12. The system of claim 8, wherein the data sources comprise unstructured data.

13. The system of claim 8, wherein the matrix cells are organized along a first axis representing client satisfaction and a second axis representing operational performance, and wherein each matrix cell is labelled according to a combined range of calculated client satisfaction and operational performance over specified time periods.

14. The system of claim 13, wherein each matrix cell is further labelled according to a degree of congruity between calculated client satisfaction and operational performance over the specified time periods.

15. A computer program product for integrating service performance data, the computer program product comprising a computer readable storage medium having program instructions embodied therewith, the program instructions executable by a computer to cause the computer to perform the steps of:
collecting client satisfaction data for a service provider from a number of data sources;
collecting operational data for the service provider from a number of data sources;
correlating the client satisfaction data with the operational data according Bayesian probability distributions;
categorizing the correlated client satisfaction data and operational data into number of performance zones according to a number of business rules;
displaying the client satisfaction data and operational data in a matrix graphical user interface comprising a number of matrix cells, wherein each matrix cell represents a different performance zone to denote a status of a service project; and
assigning a number of clients to respective performance zones in the matrix according to a Bayesian probability.

16. The computer program product of claim 15, wherein the client satisfaction data comprises at least one of:
client relationship survey scores;
Net Promoter Score (NPS);
client satisfaction (CSAT) scores;
client comments in text form;
comments from service provider employees.

17. The computer program product of claim 15, wherein operational data comprises at least one of:
project health dashboard status;
service level agreement (SLA) penalties;
key performance indicator (KPI) data;
service outages;
project revenue data;
employee productivity data;
predefined major incidents.

18. The computer program product of claim 15, wherein the data sources comprise structured data.

19. The computer program product of claim 15, wherein the data sources comprise unstructured data.

20. The computer program product of claim 15, wherein the matrix cells are organized along a first axis representing client satisfaction and a second axis representing operational performance, and wherein each matrix cell is labelled according to a combined range of calculated client satisfaction and operational performance over specified time periods and according to a degree of congruity between calculated client satisfaction and operational performance over the specified time periods.
